(19) United States
(12) Patent Application Publication
(10) Pub. No.: US 2011/0101798 A1
(43) Pub. Date: May 5, 2011

(54) SPRING FOR LINEAR VIBRATION MOTORS

(76) Inventors: Jee Sung LEE, Gyunggi-do (KR); Kwang Hyung Lee, Gyunggi-do (KR); Kyung Ho Lee, Gyunggi-do (KR)

(21) Appl. No.: 12/753,665

(22) Filed: Apr. 2, 2010

(30) Foreign Application Priority Data
Nov. 2, 2009 (KR) 10-2009-0105058

(51) Int. Cl. H02K 33/00

(52) U.S. Cl. 310/29

(57) ABSTRACT

Disclosed herein is a spring for a linear vibration motor. The spring elastically supports a vibrator to a stator of the linear vibration motor. The vibrator linearly vibrates using electromagnetic force generated by interaction between a coil and a magnet. The spring is provided between the stator and the vibrator. The spring includes a body part and an elastic part. The elastic part is coupled at a first end thereof to the body part. The elastic part extends a predetermined length such that a second end thereof is spaced apart from the body part.

### CROSS REFERENCE TO RELATED APPLICATION

This application claims the benefit of Korean Patent Application No. 10-2009-0105058, filed Nov. 2, 2009, entitled “A spring member of linear vibration motor”, which is hereby incorporated by reference in its entirety into this application.

### BACKGROUND OF THE INVENTION

1. Technical Field

The present invention relates to a spring for linear vibration motors.

2. Description of the Related Art

Generally, vibration motors are one of several signal reception indicating units used in communication devices, such as cellular phones. The vibration motors convert electric energy into mechanical vibration by the use of a principle generating electromagnetic force. Such a vibration motor is widely used as a mute signal reception indicating unit in cellular phones.

Recently, cellular phones using touch screens have rapidly increased in number, and vibration motors are also widely used in the touch screen cellular phones. A vibration motor used in a touch screen cellular phone is increasing in frequency of use, compared to that of the case where it is used only as a signal reception indicating unit. Therefore, an increase of the operational lifetime of the vibration motor is required. In addition, high responsivity corresponding to rapid touch speed is required to enhance touch satisfaction of a user.

Meanwhile, vibration motors according to conventional techniques have mainly used a method in which mechanical vibration is generated by rotating a rotor having an eccentric weight. The rotation of the rotor is implemented by a commutator or brush motor structure which commutates current through a contact point between the brush and the commutator and then supplies the current to a coil of the rotor.

However, in such a conventional vibration motor, when the brush passes through a gap between segments of the commutator, mechanical friction, electric sparks or abrasion is induced, thus creating impurities, such as black powder, thereby reducing the lifetime of the vibration motor. Furthermore, after voltage is applied, the time taken to reach a to desired quantity of vibration becomes relatively long because of rotational inertia.

Particularly, due to this problem, the conventional vibration motor cannot realize a vibrating motion suitable for touch screen cellular phones. In an effort to overcome the above-mentioned problems, a linear vibration motor which is able to reliably obtain linear vibration was proposed.

FIGS. 1 and 2 are conceptual views respectively illustrating a vertical linear vibration motor and a horizontal linear vibration motor, according to conventional techniques. As shown in FIGS. 1 and 2, in the vibration motors 10 and 10′, a vibrator 30 is elastically supported by a stator 20 through a spring 40 so as to be able to vibrate in the vertical or horizontal direction. Referring to FIG. 1, in the vertical linear vibration motor 10, the upper end of the vibrator 30 is connected to the upper end of the stator 20 by the spring 40, so that the vibrator 30 vibrates in the vertical direction (upward and downward directions; A). Referring to FIG. 2, in the horizontal linear vibration motor 10′, both ends of the vibrator 30 are respectively connected to the sidewalls of the stator 20 by springs 40, so that the vibrator 30 vibrates in the horizontal direction (leftward and rightward directions; B).

Typically, a coil spring or a plate spring is used as the spring 40 for the linear vibration motor 10, 10′. Recently, a plate spring is mainly used, because straight motion is ensured by virtue of high axial stiffness with respect to the direction other than the vibration direction, although it has the disadvantage of a lifetime shorter than the coil spring. FIGS. 3A and 3B are views respectively illustrating the structures of plate springs 40a and 40b which are used in typical linear vibration motors, according to conventional techniques.

As shown in FIGS. 3A and 3B, the plate springs 40a and 40b according to the conventional techniques are configured such that both ends of an elastic part 44 are connected to a body part 42 which is fastened to a stator. In addition, a medial portion 46 to of the elastic part 44 is coupled to the vibrator.

However, in the plate springs 40a and 40b according to the conventional techniques, because both ends of the elastic part 44 are connected (fixed) to the body part 42, the degree of freedom of the elastic part 44 is restricted. As a result, the maximum stress applied to the elastic part 44 is increased, thus reducing the lifetime of the plate spring 40a, 40b.

Meanwhile, in the plate springs 40a and 40b according to conventional techniques, to control the spring constant of the elastic part 44 and minimize the maximum stress applied thereto, the elastic part 44 has a curved shape. As a result, a rocking mode in which the vibrator is undesirably rotated when vibrating is induced.

### SUMMARY OF THE INVENTION

The present invention has been made in an effort to provide a spring for linear vibration motors which minimizes the maximum stress applied to the spring, thus increasing the lifetime.

The present invention has been made in an effort to provide a spring for linear vibration motors which avoids a conventional problem of a rocking mode in which a vibrator may undesirably rotate due to the structural characteristics of the spring when vibrating.

In a spring for a linear vibration motor according to an embodiment of the present invention, the spring elastically supports a vibrator to a stator of a linear vibration motor.

The vibrator linearly vibrates using electromagnetic force generated by interaction between a coil and a magnet. The spring includes a body part and an elastic part. The body part is fastened to the stator. The elastic part is coupled at a first end thereof to the body part. The elastic part extends a predetermined length such that a second end thereof to is spaced apart from the body part.

The elastic part may have a linear shape.

The body part may have a closed loop structure having an opening therein. The first end of the elastic part may be coupled to the inner edge of the body part.

The elastic part may be configured such that a width and a thickness thereof are constant or vary.

The elastic part may comprise a plurality of elastic parts coupled to the body part.

The plurality of elastic parts may comprise a first elastic part and a second elastic part. The first elastic part may be coupled at a first end thereof to a first end of the body part. The second elastic part may be coupled at a first end thereof to a second end of the body part which is opposite to the first end of the body part. The second elastic part may be separated from the first elastic part.

The first elastic part and the second elastic part may be parallel to each other.

The second end of the elastic part which is connected to the vibrator may have a polygonal or circular shape.

In a spring for a linear vibration motor according to another embodiment of the present invention, the spring elastically supports a vibrator to a stator of a linear vibration motor. The vibrator linearly vibrates using electromagnetic force generated by interaction between a coil and a magnet. The spring includes a first spring member and a second spring member. Each of the first and second spring members includes a body part and an elastic part. The elastic part is coupled at a first end thereof to the body part. The elastic part extends a predetermined length such that a second end thereof is spaced apart from the body part. The body part of the first spring member is fastened to the stator. The body part of the second spring member is fastened to the vibrator. The second end of the elastic part of the first spring member is connected to the second end of the elastic part of the second spring member.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are conceptual views respectively illustrating a vertical linear vibration motor and a horizontal linear vibration motor, according to conventional techniques;

FIGS. 3A and 3B are views showing the structures of plate springs used in typical linear vibration motors, according to conventional techniques;

FIG. 4 is a plan view of a spring for linear vibration motors, according to a first embodiment of the present invention;

FIGS. 5A and 5B are plan views of examples of a spring for linear vibration motors, according to a second embodiment of the present invention;

FIG. 6 is a perspective view of a spring for linear vibration motors, according to a third embodiment of the present invention;

FIG. 7 is a sectional view of a vertical linear vibration motor having the spring according to the present invention; and

FIG. 8 is an exploded perspective view of a horizontal linear vibration motor having the springs according to the present invention.

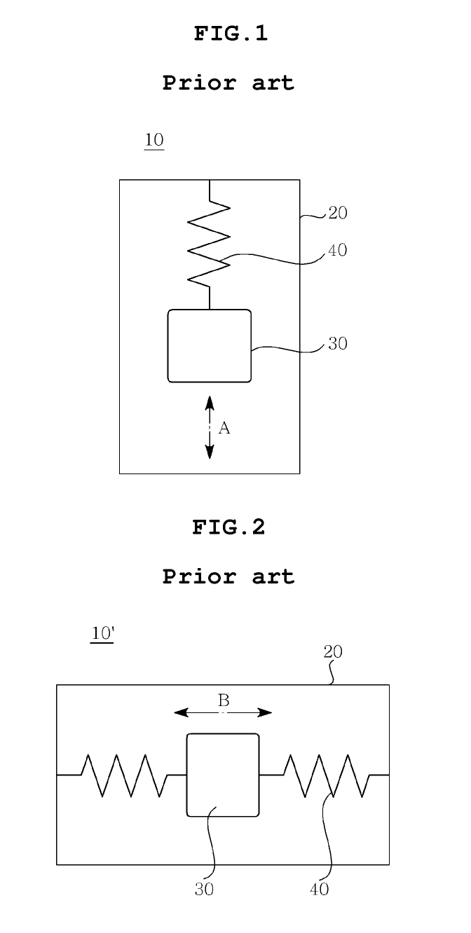

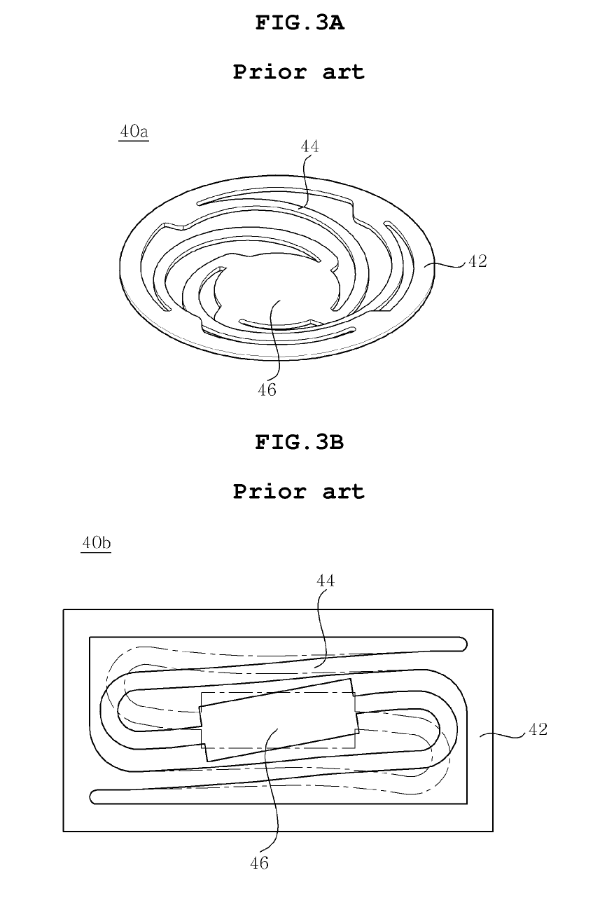

### DESCRIPTION OF THE PREFERRED EMBODIMENTS

Reference now should be made to the drawings, in which the same reference numerals are used throughout the different drawings to designate the same or similar components. In the following description, when it is determined that the detailed description of the conventional function and conventional structure would confuse the gist of the present invention, such a description may be omitted. Furthermore, the terms and words used in the specification and claims are not necessarily limited to typical or dictionary meanings, but must be understood to indicate concepts selected by the inventor as the best method of illustrating the present invention, and must be interpreted as having had their meanings and concepts adapted to the scope and sprit of the present invention so that the technology of the present invention could be better understood.

Hereinafter, embodiments of the present invention will be described in detail with reference to the accompanying drawings.

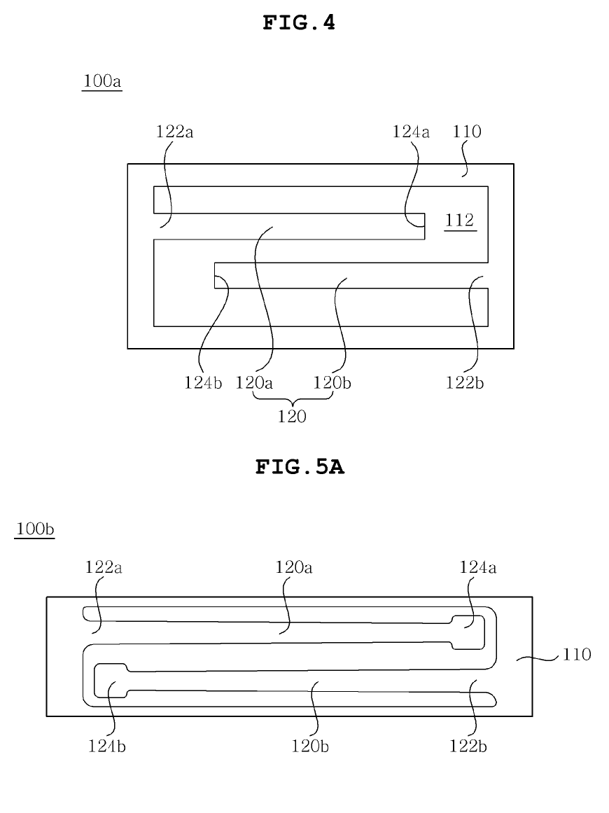

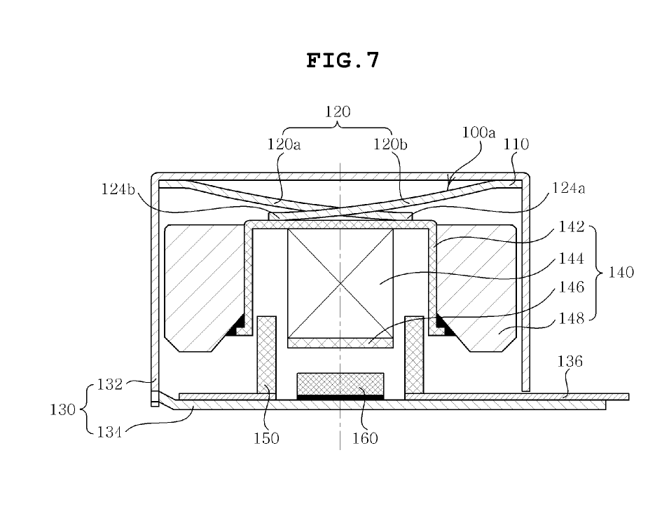

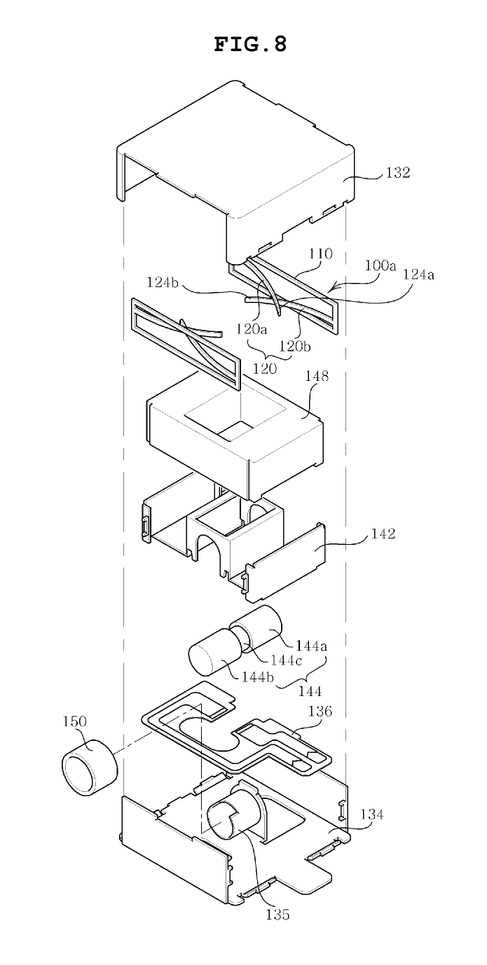

FIG. 4 is a plan view illustrating a spring 100a for a linear vibration motor, according to a first embodiment of the present invention. Below the spring 100a for a linear vibration motor according to the first embodiment of the present invention will be explained in detail with reference to FIG. 4. Meanwhile, linear vibration motors having the spring 100a according to the first embodiment of the present invention will be explained in more detail in the description of FIGS. 7 and 8.

As shown in FIG. 4, the spring 100a for a linear vibration motor according to the first embodiment of the present invention elastically supports a vibrator on a stator. Here, the vibrator linearly vibrates using electromagnetic force generated by interaction between a coil and a magnet. The spring 100a includes a body part 110 which is fastened to the stator, and elastic parts 120 which protrude inwards from the body part 110 such that first ends thereof are coupled to the body part 110 and second ends thereof are spaced apart from the body part 110.

The body part 110 is fastened to the stator of the linear vibration motor. The body part 110 has a closed loop structure having an opening 112 therein. In the first embodiment of the present invention, as shown in the drawing, the body part 110 has a to rectangular frame shape, but it is not limited to this shape.

The elastic parts 120 elastically support the vibrator using the elastic force. In detail, each elastic part 120 protrudes inwards from the body part 110 such that the first end 122a, 122b thereof is coupled to the body part 110 and the second end 124a, 124b thereof is spaced apart from the body part 110. Here, only the first end 122a, 122b of each elastic part 120 is coupled to the inner edge of the body part 110. As such, in the present invention, because portions of the elastic part 120 other than the first end 122a, 122b are separated from the body part 110 and, in particular, the second end 124a, 124b forms a free end, the maximum stress applied to the spring 100a can be markedly reduced compared to the conventional structure in which both ends of the elastic part are coupled to the body part. In addition, the present invention can overcome limitations in the degree of freedom, thus maximizing the function of the elastic part 120 as an elastic body.

In the first embodiment, the elastic part 120 has a linear shape to prevent the elastic part 120 from impeding straight motion of the linear vibration motor. In other words, the elastic part 120 is linear from the first end 122a, 122b coupled to the body part 110 to the second end 124a, 124b.

Here, the spring constant of the elastic part 120 can be adjusted by changing the thickness, width, length, etc. thereof. Due to this, the present invention can easily cope with the requirement of different resonant frequencies. In the present invention, because the second end 124a, 124b of the elastic part 120 has a free end structure, the thickness, width, length, etc. of the elastic part 120 can be easily controlled. Meanwhile, the spring constant of the spring 100a can be controlled by changing the number of elastic parts 120. As necessary, the spring 100a may have a single elastic part 120 or a plurality of elastic parts 120. For example, in the case where the spring 100a has two elastic parts 120, a first elastic part 120a is coupled at a first end 122a thereof to a first end of the body part 110. Furthermore, the first elastic part 120a extends from the to body part 110 such that a second end 124a thereof is spaced apart from the body part 110. A second elastic part 120b is coupled at a first end 122b thereof to a second end of the body part 110 which is opposite to the first end of the body part 110. The second elastic part 120b extends from the body part 110 such that a second end 124b thereof is spaced apart from the body part 110 and the first elastic part 120a. Here, the first elastic part 120a and the second elastic part 120b have linear shapes and are parallel to each other such that they are separated from each other.

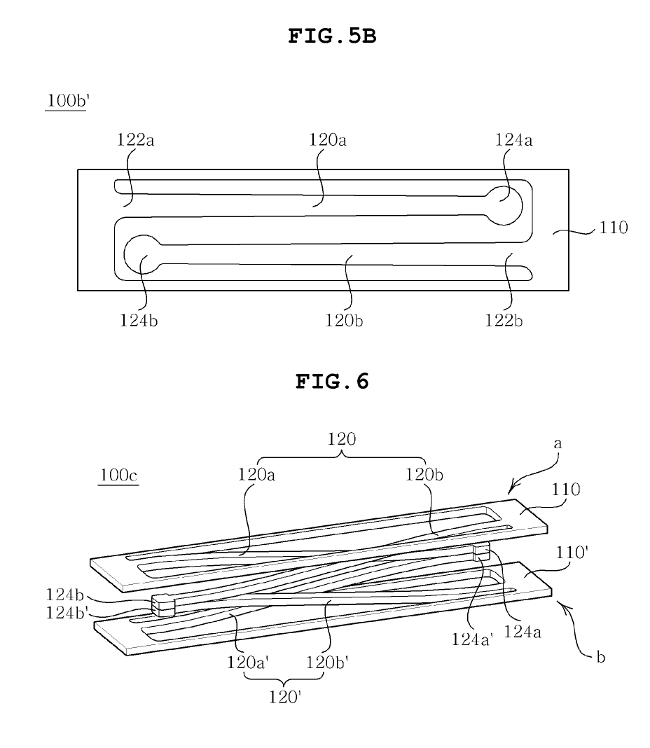

FIGS. 5A and 5B are plan views showing examples of a spring for a linear vibration motor, according to a second embodiment of the present invention. Hereinafter, the spring 100b, 100b′ for a linear vibration motor according to the second embodiment of the present invention will be described in detail with reference to FIGS. 5A and 5B.

As shown in FIGS. 5A and 5B, the spring 100b, 100b′ according to the second embodiment is characterized in that second ends 124a and 124b of elastic parts 120a and 120b have polygonal shapes (refer to FIG. 5A) or circular shapes (refer to FIG. 5B). The general structure of the spring 100b, 100b′ according to the second embodiment, with the exception of the above-mentioned structure, remains the same as that of the first embodiment, therefore further explanation is deemed unnecessary.

As such, in the spring 100b, 100b′ according to the second embodiment, the second ends 124a and 124b of the elastic parts 120a and 120b which are connected to a vibrator have various shapes, thus increasing contact areas between the vibrator and the elastic parts 120a and 120b, thereby enhancing the reliability of connection in the junctions therebetween.

FIG. 6 is a perspective view of a spring 100c for linear vibration motors, according to a third embodiment of the present invention. Hereinafter, the spring 100c for linear vibration motors according to the third embodiment of the present invention will be described in detail with reference to FIG. 6.

As shown in FIG. 6, the spring 100c according to the third embodiment of the present invention is constructed such that two spring members a and b are connected to each other. In detail, the spring 100c according to the third embodiment includes a first spring member a and a second spring member b. The first spring member a includes a body part 110 which is fastened to a stator, and elastic parts 120 which extend from the body part 110. The second spring member b includes a body part 110′ which is fastened to a vibrator, and elastic parts 120′ which extend from the body part 110′. Furthermore, second ends 124a of the elastic parts 120a and 120b of the first spring a are respectively connected to second ends 124a′ and 124b′ of the elastic parts 120a′ and 120b′ of the second spring b. Here, the structure of each spring member a, b is the same as that of the spring 100a of the first embodiment, therefore further explanation will be omitted. As such, because the third embodiment is configured such that the two spring members a and b are doubly united with each other, problems due to limitation in length of the elastic part can be avoided.

The first spring member a has the same structure as that of the second spring member b. In the third embodiment, to prevent deterioration of the straightness of the elastic parts 120 and 120′, each elastic part 120 is connected to the corresponding elastic part 120′. In detail, the second end 124a of the first elastic part 120a of the first spring member a is connected to the second end 124a′ of the first elastic part 120a′ of the second spring member b. The second end 124b of the second elastic part 120b of the first spring member a is connected to the second end 124b′ of the second elastic part 120b′ of the second spring member b.

FIG. 7 is a sectional view showing a vertical linear vibration motor having the spring according to the present invention. Hereinafter, the vertical linear vibration motor having the spring 100a according to the present invention will be described in detail with reference to FIG. 7. The vertical linear vibration motor illustrated in FIG. 7 is only one illustrative example of linear vibration motors in which a vibrator vibrates in the vertical direction. Accordingly, the use of the spring according to the present invention is not limited to the vertical linear vibration motor illustrated in FIG. 7.

As shown in FIG. 7, the vertical linear vibration motor includes a stator 130, a vibrator 140 and the spring 100a. The stator 130 includes a casing 132 and a bracket 134 which are assembled with each other such that an internal space is defined therein. Furthermore, a circuit board 136 and a hollow coil 150 are installed in the lower portion of the stator 130. The vibrator 140 includes a yoke 142, a magnet 144 and a weight 148. The yoke 142 has a hollow space which is closed on one end thereof and is open on the other end thereof. The magnet 144 is installed in the hollow space of the yoke 142. In addition, a plate yoke 146 is attached to the lower surface of the magnet 144. The weight 148 is fitted over the circumferential outer surface of the yoke 142. The spring 100a is fastened to the upper end of the stator 130. Furthermore, the spring 100a elastically supports the vibrator 140 such that the vibrator 140 linearly vibrates in the vertical direction. As well, a damper 160 may be provided in the stator 130. The damper 160 limits displacement of the vibrator 140 that vibrates in the vertical direction. In addition, the damper 160 absorbs shocks generated by collision between the vibration 140 and the stator 130, for example, when the linear vibration motor falls down onto the ground or the vibrator 140 vibrates, thus enhancing the durability of the motor, and minimizing noise attributable to friction when operating.

In the vertical linear vibration motor having the above-mentioned construction, when power is supplied to the hollow coil 150, the vibrator 140 is vibrated by the spring 100a in the vertical direction because of interaction between a magnetic field which is generated by the magnetic circuit including the magnet 144, the plate yoke 146 and the yoke 142, and an electric field which is generated by the hollow coil 150.

Here, the body part 110 of the spring 100a is fastened to the upper end of the stator 130. The elastic parts 120 which extend to predetermined lengths are coupled at the first ends thereof to the body part 110 and coupled at the second ends 124a and 124b to the vibrator 140, in detail, to the upper surface of the yoke 142. Thereby, the spring 100a can elastically support the vibrator 140 which vibrates in the vertical direction.

Meanwhile, although the spring 100a according to the first embodiment has been illustrated as being used in the vertical linear vibration motor of FIG. 7, this is only one illustrative example, and it will be easily understood that the spring 100b, 100b′ or 100c according to the second or third embodiment can also be used.

FIG. 8 is an exploded perspective view illustrating a horizontal linear vibration motor having the springs 100a according to the present invention. Hereinafter, the horizontal linear vibration motor having the springs 100a according to the present invention will be described in detail with reference to FIG. 8. The horizontal linear vibration motor illustrated in FIG. 8 is only one illustrative example of a linear vibration motor in which a vibrator vibrates in the horizontal direction. Therefore, the use of the spring for linear vibration motors according to the present invention is not limited to the horizontal linear vibration motor illustrated in FIG. 8.

As shown in FIG. 8, the horizontal linear vibration motor includes a stator, a vibrator and the springs 100a. The stator includes a casing 132 and a bracket 134 which are assembled with each other such that an internal space is defined therein. Furthermore, a circuit board 136 and a hollow coil 150 which is supported by a bobbin 135 are installed in the lower portion of the stator. The vibrator 140 includes a magnetic unit. In the magnetic unit, magnets 144a and 144b are provided on opposite sides of a magnetic core 144c such that the same poles of the magnets 144a and 144b face each other. A yoke 142 covers the sidewalls of the magnets 144a and 144b. A weight 148 is coupled to the yoke 142. The springs 100a elastically support the vibrator such that the vibrator linearly vibrates in the horizontal direction.

In the horizontal linear vibration motor having the above-mentioned construction, when power is supplied to the hollow coil 150, the vibrator is horizontally vibrated leftwards and rightwards by the springs 100a because of interaction between an electric field generated by the hollow coil 150 and a magnetic field which is generated by the magnetic unit including the magnets 144a and 144b which are provided through the hollow coil 150.

Here, the body parts 110 of the springs 100a are fastened to the stator, in detail, to the sidewalls of the brackets 134. The elastic parts 120 which extend to predetermined lengths are coupled at the first ends thereof to the body parts 110 and fastened at the second ends 124a and 124b thereof to the vibrator 140, in detail, to the sidewalls of the weight 148. Thereby, the springs 100a can elastically support the vibrator which vibrates in the horizontal direction.

As described above, in a spring for a linear vibration motor according to the present invention, a second end of an elastic part is spaced apart from a body part, thus forming a free end. Therefore, compared to the conventional structure in which both ends of the elastic part are fixed, the maximum stress applied to the spring can be minimized In addition, the present invention can overcome limitations in the degree of freedom, thus maximizing the function of the elastic part as an elastic body.

Furthermore, in the spring of the present invention, the elastic part has a linear shape, thus preventing a problem of a rocking mode in which the vibrator may undesirably rotate due to the structural characteristics of the spring when vibrating.

In addition, because the second end of the elastic part has the free end structure, the width, the thickness, the length, the number of elastic parts, etc. can be easily adjusted. Thus, the spring constant of the spring can be easily controlled and thus the requirements of various resonant frequencies can be easily coped with.

Moreover, the spring according to the present invention may be configured such to that two spring members in which second ends of elastic parts have free end structures are connected to each other. Therefore, even though each elastic part is relatively short, the spring of the present invention can easily cope with the requirement of providing a desired spring constant.

Although the embodiments of the present invention have been disclosed for illustrative purposes, it will be appreciated that the spring for a linear vibration motor according to the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spring for elastically supporting a vibrator to a stator of a linear vibration motor, the vibrator linearly vibrating using electromagnetic force generated by interaction between a coil and a magnet, the spring comprising:
a body part fastened to the stator; and
an elastic part coupled at a first end thereof to the body part, the elastic part extending a predetermined length from the body part such that a second end thereof is spaced apart from the body part.

2. The spring as set forth in claim 1, wherein the elastic part has a linear shape.

3. The spring as set forth in claim 1, wherein the body part has a closed loop structure having an opening therein, and the first end of the elastic part is coupled to an inner edge of the body part.

4. The spring as set forth in claim 1, wherein the elastic part is configured such that a width and a thickness thereof are constant or vary.

5. The spring as set forth in claim 1, wherein the elastic part comprises a plurality of elastic parts coupled to the body part.

6. The spring as set forth in claim 5, wherein the plurality of elastic parts comprises:
a first elastic part coupled at a first end thereof to a first end of the body part; and
a second elastic part coupled at a first end thereof to a second end of the body part which is opposite to the first end of the body part, the second elastic part being separated from the first elastic part.

7. The spring as set forth in claim 6, wherein the first elastic part and the second elastic part are parallel to each other.

8. The spring as set forth in claim 1, wherein the second end of the elastic part which is connected to the vibrator has a polygonal or circular shape.

9. A spring for elastically supporting a vibrator to a stator of a linear vibration motor, the vibrator linearly vibrating using electromagnetic force generated by interaction between a coil and a magnet, the spring comprising a first spring member and a second spring member, each of the first and second spring members comprising:
a body part; and
an elastic part coupled at a first end thereof to the body part, the elastic part extending a predetermined length from the body part such that a second end thereof is spaced apart from the body part,
wherein the body part of the first spring member is fastened to the stator, the body part of the second spring member is fastened to the vibrator, and the second end of the elastic part of the first spring member is connected to the second end of the elastic part of the second spring member.
